(19) United States
(12) Patent Application Publication
(10) Pub. No.: US 2020/0223127 A1
(43) Pub. Date: Jul. 16, 2020

(54) 3-D PRINTING METHOD HAVING INCREASED STRENGTH OF THE PRODUCED OBJECT

(71) Applicant: Robert Bosch GmbH, Stuttgart (DE)

(72) Inventors: Hendrik Jahnle, Leutenbach (DE); Florian Fischer, Hirschberg An Der Bergstrasse (DE); Norman Lung, Weinstadt (DE)

(21) Appl. No.: 16/461,625

(22) PCT Filed: Oct. 4, 2017
(86) PCT No.: PCT/EP2017/075138

§ 371 Date: Feb. 6, 2020

(30) Foreign Application Priority Data
Nov. 16, 2016 (DE) 10 2016 222 558.8

(51) Int. Cl. B29C 64/106; B33Y 10/00; B33Y 30/00; B33Y 70/10; B29C 64/209; B29C 64/245

(52) U.S. Cl. CPC B29C 64/106; B33Y 10/00; B33Y 30/00; B29K 2105/0002; B29C 64/209; B29C 64/245; B29K 2089/00; B33Y 70/10

(57) ABSTRACT

The invention relates to a method (100) for producing a three-dimensional object (10), having the following steps: a printing structure (11), which defines an interior (12), is produced (110) from a printing material (21) by means of 3-D printing; a filling material (22), which comprises at least one liquid or pasty monomer (23), is introduced (120) into the interior (12); the monomer (23) is polymerized (130) to form a polymer (24). The invention further relates to a 3-D printer (30) for performing the method (100), wherein a first printing head (31) for the printing material (21) and a second printing head (32) for the filling material (22) are provided, wherein the outlet opening (32a) of the second printing head (32) for the filling material (22) has a cross-sectional area that is greater than that of the outlet opening (31a) of the first printing head (31) for the printing material (21) by a factor of at least 2, preferably by a factor of at least 5, and/or a base plate (33) is provided, on which the printing structure (11) should be constructed, wherein the base plate (33) has a feed-through (34) for the filling material (22), which feed-through can be connected, on the side facing away from the printing structure (11), to a pressurized source (26) for the filling material (22).

### BACKGROUND OF THE INVENTION

The present invention relates to a 3D printing method for producing three-dimensional objects with freely selectable shaping.

In conventional 3D printing (fused deposition modeling, FDM), a thermoplastic printing material is melted and applied in the liquid state selectively at the position is which belong to the object to be produced. When the printing material subsequently cools, it resolidifies. In this way, objects with freely selectable shaping can be constructed layerwise.

In order to increase the strength of the objects produced, it is known from US 2016/046 803 A1 to use a polymerizable monomer, to which a reinforcing substance in fiber form is added, as the printing material. In this case, the printing material may have a consistency in which it can be applied in a step of a plurality of layers, so that a three-dimensional precursor object is formed. The monomer may then be polymerized en bloc in the continuous precursor object.

This printing method requires compromises in relation to the achievable shaping, particularly as regards intricate contours. The printed structures must remain stable at least until the precursor object is solidified by the polymerization.

### SUMMARY OF THE INVENTION

In the scope of the invention, a method for producing a three-dimensional object has been developed. In this method, a printed structure is initially manufactured by means of 3D printing from a printing material. This printed structure defines an internal space. A filling material, which comprises at least one liquid or paste-like monomer, is subsequently introduced into the internal space. Lastly, the monomer is polymerized to form a polymer.

The functional the internal space is in this context, when filling with the filling material, to spatially limit the propagation of the latter. To this end, it is not necessary for the internal space to be enclosed on all sides.

For example, an upwardly open trough manufactured from the printing material also defines an internal space which may be filled with the filling material. The filling material is then held in this trough and cannot flow out. The internal space may come in particular, define the negative shape of the object structure to be produced from the polymer, or a part of such an object structure.

The term “manufactured by means of 3D printing” includes any manufacturing in which 3D printing is employed. The printed structure is thus also manufactured by 3D printing in the sense of the invention when, for example, the printing material has been cast into a mold which itself is been produced directly by means of 3D printing.

It has been discovered that, with the method according to the invention, much finer object structures can be manufactured from the polymer that according to the prior art, and that a larger class of object structure can actually be affected. The high precision with which the printed structure can be manufactured by 3D printing is imparted to the contours of the internal space, which in turn establish the positions to which the filling material penetrates. In this case, there is no longer the constraint that the object structures must remain independently stable until the polymerization. Nevertheless, it is as before possible to polymerize the monomer en bloc, so that there are no interfaces between regions polymerized in chronological succession inside the object structures which consist of the polymer. It is at such interfaces that the polymer is weakest and preferentially breaks under mechanical loading of the object. The strength cannot even be improved at these interfaces by the use of reinforcing fibers, since the fibers do not bridge these interfaces.

It has furthermore been discovered that in particular solid objects made of the polymer, which also have intricate structures, can be manufactured particularly rapidly in this way. In order to produce intricate structures by means of 3D printing, a nozzle with a small outlet opening for the liquid printing material is required. This in turn has the effect that the mass flow through the outlet opening is limited and filling an object takes a long time. By now initially defining the internal space by means of 3D printing in solid form and subsequently introducing the filling material into it, the fineness of the final object structures and the mass flow of filling material are mutually decoupled.

When entering the internal space, the filling material preferably has a temperature which is lower than the melting temperature of the solidified printing material. The printed structure is then not attacked by the filling material. The filling material may, however, also be popular if and when it can be dissipated sufficiently through the printed structure in order to keep the temperature of the printed structure below its melting temperature T_{M}.

In one particularly advantageous configuration of the invention, a filling material which contains at least one solid filler is selected. This fella may fulfill any desired function. For example, the pillar may be a recycled material, the use of which reduces the material costs of the object produced. The filler may also, for example, be a material which gives the object a weight required for its use.

In one particularly advantageous configuration of the invention, a reinforcing substance, particularly in the form of fibers, is selected as the filler. For example, glass fibers are suitable. The use of such reinforcing substances in printing materials has to date lead to a further conflict of claims in relation to intricate structures, since a nozzle required for intricate structures, with a small outlet opening, is susceptible of being clogged by the reinforcing substances. By the addition of fibers, functional reinforcing effects can be achieved which lead to a significant increase in the mechanical properties. At the same time, owing to the polymerization in one piece, the mechanical strength of the collar is isotropic.

In another particularly advantageous configuration of the invention, the printing material is composed with a first 3D printing head to form the printed structure, and the filling material is introduced into the internal space with a second 3D printing head. In this way, it is possible to ensure that the filling material only enters the internal space, and other regions on the outside of the printed structure are not contaminated. Such contamination may possibly only be removable with difficulty after the polymerization of the monomer. It furthermore ensures that the outer surface of the printed structure is free of loose reinforcing substances. Such foreign bodies could, for example in fuel systems, in the function of valves or damage a high-pressure pump.

Advantageously, the outlet opening of the second printing head for the filling material has a cross-sectional area which is greater by a factor of at least 2, preferably by a factor of at least 5, than the outlet opening of the first printing head for the printing material. This division of labor ensures that the fine contours of the printed structure and be manufactured with high precision, while at the same time the internal space is filled with a high mass flow of filling material.

In another particularly advantageous configuration of the invention, a water-soluble material, in particular gelatin, is selected. In particular, in another particularly advantageous configuration of the invention, this makes it easier to remove the printed structure from the object after the polymerization of the monomer.

If the printed structure is intended to be permanently part of the final object, in another particularly advantageous configuration of the invention the filling material is brought into engagement with indentations of the printed structure. After the polymerization of the monomer, a form-fit connection with the indentations is then formed. In particular, the printed structure can then no longer be removed or stripped from the polymer. In the sense of the invention, indentations are therefore intended in general to mean structures which, when they are brought in contact with the monomer, enter into a form-fit connection with the resulting polymer after polymerization.

The indentations may, for example, be introduced into the printed structure by porosity. In order to achieve such porosity, the parameters of the 3D printing may for example be adapted. The printed structure should then have at least a material thickness sufficient that any path from the internal space through the pore structure at any position is blocked before reaching the external space, i.e. before full passage through the printed structure, and the internal space therefor remains sealed against emergence of the filling material.

As an alternative or even in combination, the indentations may be printed structures. This makes use of the fact that 3D printing allows the introduction of any desired structures in very wide limits.

In another particularly advantageous configuration of the invention, a monomer is selected which polymerizes to form a polymer that is materially the same as the printing material. The polymer in the internal space then also chemically bonds to the printed structure. A solid object made of the polymer is thus formed overall, which at the same time has intricate outer contours, can be filled rapidly with the polymer and may be regarded as almost monobloc in relation to mechanical strength.

This is, in particular, possible because the printed structure is “freshly” manufactured at the time of filling with the feeling material, i.e. the polymer chains of the printed structure still have chemical potentials which allow bonding with the polymer resulting from the filling material. This is contributed to, on the one hand, by the fact that the printed structure can be filled relatively rapidly with the filling material. On the other hand, the production of the printed structure and the filling with the filling material may be carried out in the same device, without the printed structure being brought into a different climate in-between. If, for example, a printed structure is removed from the construction space of a first device and brought through normal atmosphere into a second device, chemical potentials of the number chains may for example be saturated with water from the air humidity, which reduces the susceptibility of the printed structure to bond with the polymer formed in the internal space.

In another particularly advantageous configuration of the invention, further printing material is applied by means of 3D printing after the introduction of the filling material. If the printed structure comprises a trough, for example, after the introduction of the filling material this trough may be closed with a printed cover. It is then no longer necessary to subsequently open an access to the internal space.

In this case, the monomer in the filling material may optionally already be polymer raised before the further printing material is applied. This further printing material then fills up any possible shrinkage of the filling material. Furthermore, overhangs of the monomer may also be cast over the printing material and subsequently printed over with printing material.

As an alternative, the monomer may initially remain as monomer and not be polymerized until a later time. This is advantageous in particular when the additionally applied printing material defines a further internal space, which together with the first internal space forms a continuous region filled with filling material. The monomer may then be polymerized en bloc in this region, so that in the polymer finally obtained there is no interface formed by the boundary between the two internal spaces, and therefor also no possible weak point.

If the intention is to switch over, in particular repeatedly, between the application of printing material and the introduction of filling material, the printing head, or the printing heads, of the 3D printer used is or are advantageously configured in such a way that emergence of printing material, or respectively of filling material, can be prevented by the presence of a reduced pressure at the outlet opening, and/or by a valve closure of the outlet opening.

In another particularly advantageous configuration of the invention, the internal space is connected during the polymerization of the monomer to a pressurized source of the filling material. In this way, the shrinkage which takes place during the polymerization may be compensated for by replenishing with further filling material in the scope of the shrinkage. The shrinkage may be of the order of 10%. If the polymerization is for example carried out at elevated temperature and the manufactured object is cooled to room temperature, there is then also a further shrinkage of the order of 1%.

The access to the internal space for supplying the filling material may deliberately be left open during the 3D printing of the printed structure. For example, the printed structure may be constructed on a base plate, which has a feed-through supplying the filling material. The printed structure may then be configured in such a way that a channel from this supply into the internal space remains open. The access may, however, be produced subsequently by a cut, a bore or a similar opening which leads into the internal space.

In another particularly advantageous configuration of the invention, the printed structure is constructed with the aid of a carrier structure which does not belong to the object and can be separated from the object. The carrier structure may, for example, be used as a shaping element for the 3D printing of the printed structure, by its supporting corresponding overhangs of the printing material. The object may, for example, be separated from the carrier structure by its being broken off from it or by dissolving the carrier structure. Accordingly, the carrier structure may advantageously again consist of a water-soluble material, which advantageously is biologically degradable, so that no environmentally hazardous waste is produced in particular when using the method on an industrial scale.

In another particularly advantageous configuration of the invention, the internal space encloses an insert to be embedded in the object. Such inserts may for example be conductive tracks, sockets and plugs. In particular, electronic components or permanent magnets may also be inserts. Such inserts are heat-sensitive, and therefore cannot be constructed around with many 3D printing methods, which heat the printing material to temperatures of 200° C. or more. The filling of the internal space with the filling material, however, is not necessarily contingent on a particular minimum temperature. Not even the polymerization of the monomer to form the polymer necessarily presupposes an elevated temperature, since the polymerization may also be initiated and/or sustained by a catalyst, an activator and/or by UV light. It is also possible to activate the polymerization by temporary temperature elevation, so that it subsequently continues by itself at lower temperature. The insert is then only limited the exposed to heat.

In one advantageous configuration of the invention, caprolactam is selected as the monomer and is polymerized to form the polyamide PA6 as the polymer. Particularly in connection with fibers as reinforcing substances, and object produced according to the invention from PA6 may come very close to or even surpass the mechanical and technical properties of injection-molded EA6. The configurational freedom and function-oriented design in the sense of additive manufacturing are therefore combined with the method-specific advantages of injection molding, without having to accept the specific advantages which these technologies respectively entail per se.

As an alternative or in combination, propene may be selected as a monomer and polymerized to form PBT as a polymer. Cyclic PBT or CBT may be selected as a monomer and be polymerized to form PBT as a polymer. Lastly, for example, laurolactam may also be selected as a monomer and be polymerized to form the polyamide PA12 as a polymer.

In general, the method according to the invention may enhance all 3D printing methods which operate with thermoplastics. Likewise, injection molding may be substituted particularly in prototyping and in small batch runs. In particular, it is possible to avoid the time outlay and the costs each time the injection mold is produced and modified.

Accordingly as mentioned above, the invention also relates to a 3D printer, which is configured in particular for carrying out a method according the invention in that

a first printing head for the printing material and a second printing head for the filling material are provided, the outlet opening of the second printing head for the filling material having a cross-sectional area which is greater by a factor of at least 2, preferably by a factor of at least 5, than the outlet opening of the first printing head for the printing material, and/or

a base plate is provided, on which the printed structure is to be constructed, the base plate having a feed-through for the filling material, which feed-through can be connected on the side facing away from the printed structure to a pressurized source of the filling material.

Further measures which improve the invention will be presented in more detail below together with the description of the preferred exemplary embodiments of the invention with the aid of figures.

### BRIEF DESCRIPTION OF THE DRAWINGS

FIG. 1 shows a flowchart of the method 100 according to the invention;

FIGS. 2a through 2f show an exemplary embodiment of the method 100 according to the invention;

FIG. 3 shows a variant of the method 100, carried out with a different 3D printer 30;

FIG. 4 shows an example of an indentation 13 and insert 15 in the internal space

### DETAILED DESCRIPTION

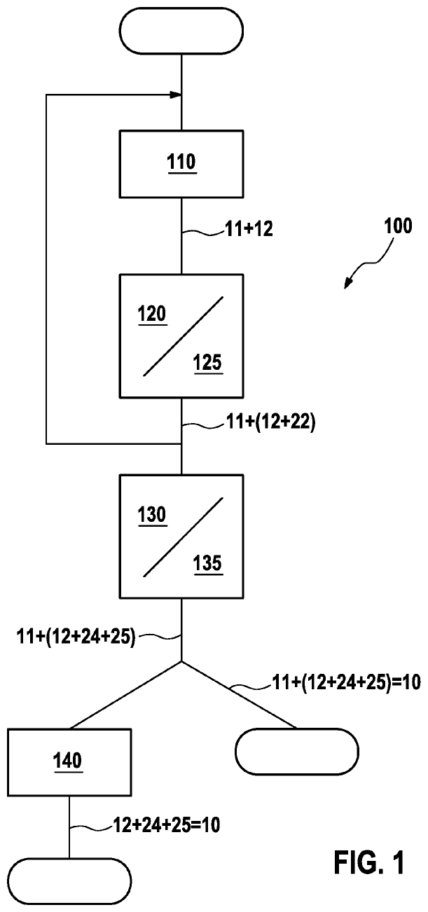

According to FIG. 1, in step 110 a printed structure 11 is first manufactured. This printed structure 11 contains an internal space 12, which is filled in step 120 with a filling material 22 that contains reinforcing fibers 25. In this case, the filling material 22 is optionally brought into engagement with indentations 13 in the printed structure. Optionally, further iterations may then take place, in which the printed structure 11 is extended and filling material 22 is introduced into corresponding internal spaces 12.

In step 130, the monomer 23 contained in the filling material 22 is polymerized to form a polymer 24, further filling material 22 optionally being supplied (step 135) during the polymerization.

Subsequently, according to the user's choice, the composite consisting of the printed structure 11 and polymer 25, reinforced with fibers 25, contained in the internal space 12 thereof, may be used as a finished object can, or the printed structure 11 may be removed in step 140.

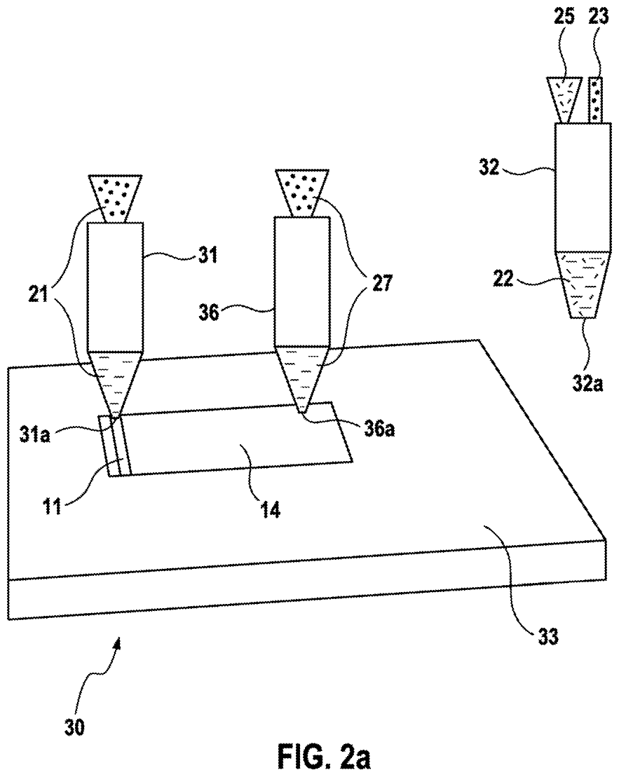

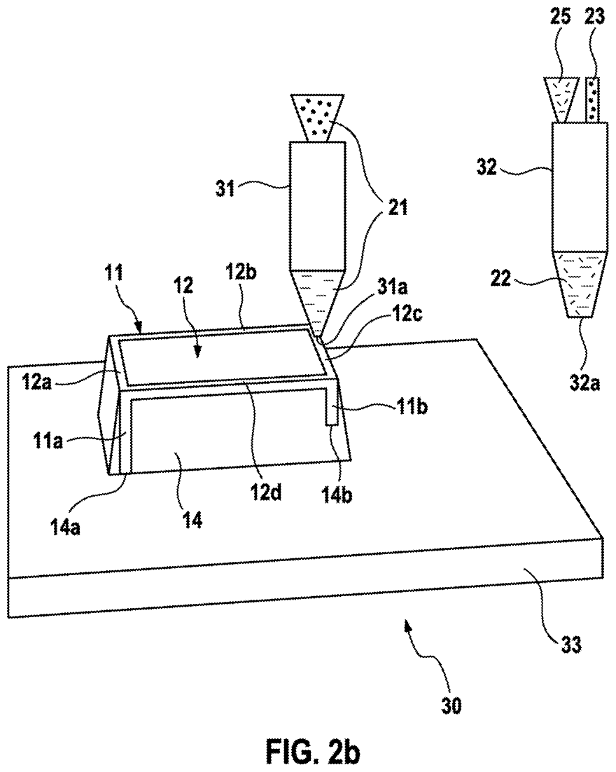

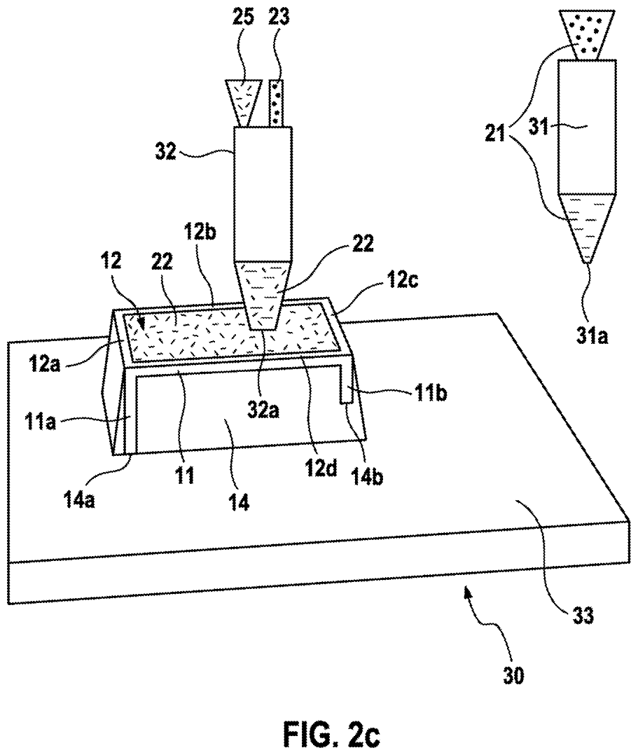

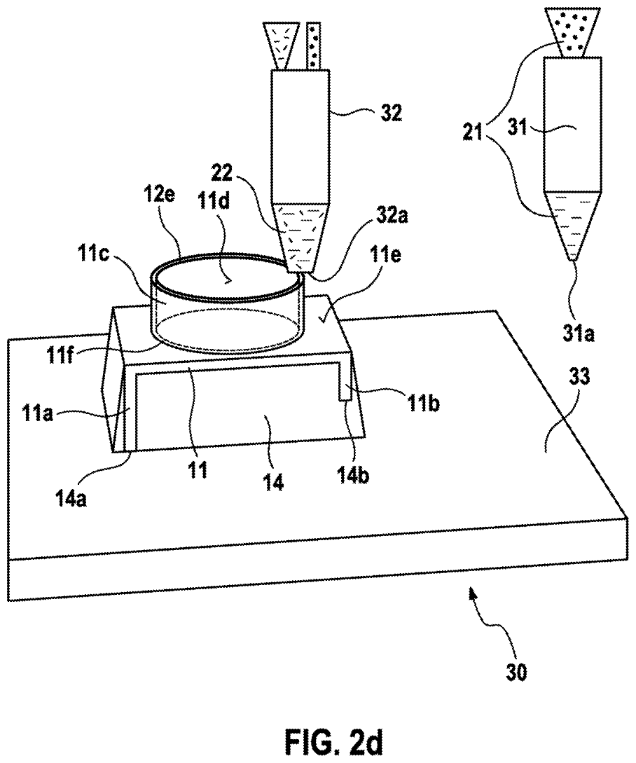

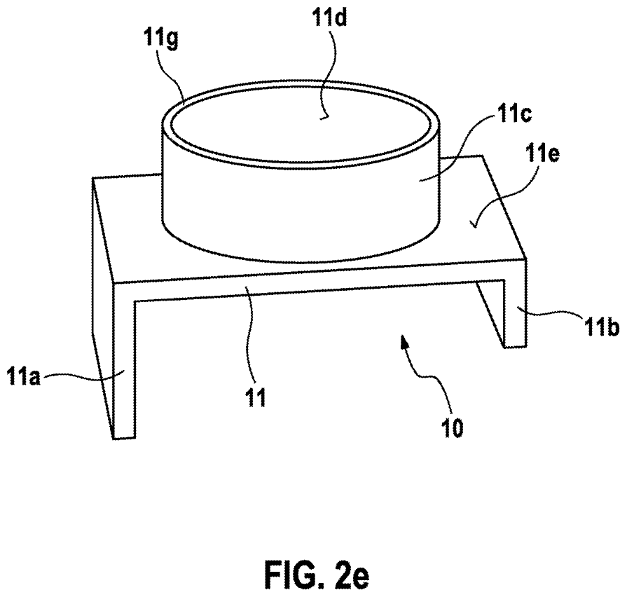

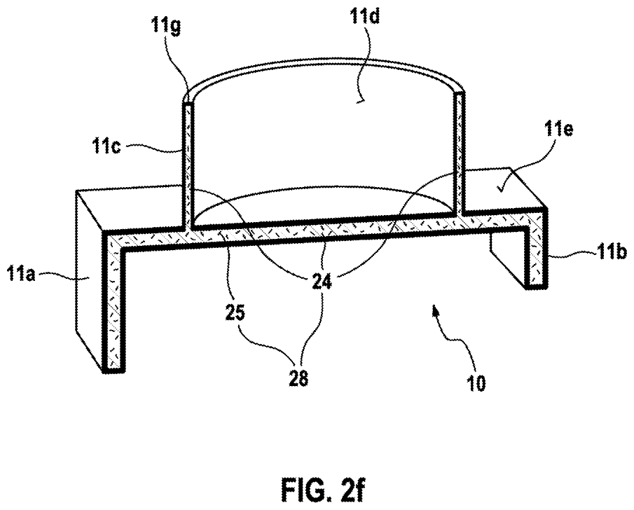

FIG. 2 illustrates by way of example the way in which an exemplary embodiment of the method 100 is carried out with an exemplary 3D printer 30.

According to FIG. 2a, the 3D printer 30 comprises a base plate 33, on which the printed structure 11 is to be constructed. The base plate 33 is arranged in a heatable construction space, which in this exemplary embodiment is at a temperature of 160° C. Furthermore, three printing heads 31, 32 and 36 are provided. The first printing head 31 heats a printing material 21 which is in the form of granules, and delivers it in plasticized form through a nozzle having an outlet opening 31a selectively at the positions which belong to the printed structure 11. The second printing head 32 receives both a monomer 23 and reinforcing fibers 25. Inside the second printing head 32, the monomer 23 and the reinforcing fibers 25 are mixed before the filling material 22, which emerges from the outlet opening 32a. The third printing head 36 heats a further material 27, which is in the form of granules, to plasticization and delivers it through its outlet opening 36a the third printing head 36 is used to apply a carrier structure 14 on the base plate 33. In each layer constructed, the material 27 of the carrier structure 14 is applied at the positions belonging to the carrier structure 14, and the printing material 21 is applied at the positions belonging to the printed structure 11.

FIG. 2b shows a snapshot at a later instant. Both the carrier structure 14 and the printed structure 11 is grown in height, with two limbs 11a and 11b of the printed structure 11 engaging in recesses 14a and 14b, corresponding thereto, of the carrier structure 14. The function of the carrier structure 14 is in this case to keep the printed structure 11 horizontal, even though the limbs 11a and 11b of different length. In the state shown in FIG. 2b, the production of the carrier structure 14 is completed; the associated third printing head 36 is therefore no longer indicated. The printed structure 11 defines an internal space 12, which is configured as a trough and is bounded by four walls 12a, 12b, 12c and 12d. The limbs 11a and 11b are also internally hollow and fillable with filling material 22, although this, be seen in the perspective selected and is therefore also not indicated.

FIG. 2c shows a snapshot at a later instant. The trough-shaped internal space 12, as well as the cavities connecting their width in the limbs 11a and 11b, are filled with the filling material 22. The filling material 22 is in this case sufficiently fluid that it can also be cast into these cavities. In other configurations, it may for example also be laid in tracks with a consistency of soft wax.

FIG. 2d shows a snapshot at a later instant. The trough-shaped internal space 12, filled with filling material 22, of the printed structure 11 has been closed with a cover 11e, which is made printing material 21 and in which a circular groove 11f is been left open. Radially on both sides of this groove 11f, two concentric cylindrical walls 11c and 11d have subsequently been constructed with the first printing head 31. Between these two cylindrical walls 11c and 11d, there is a cavity 11e which is fluidically connected to the trough-shaped internal space 12 and therefor, like the cavities in the limbs 11a and 11b, is functionally to be assigned to this internal space 12. In the state shown in FIG. 2d, the second printing head is in the process of filling the cavity 12e with further filling material 22. The sooner this is completed, the monomer 23 contained in all of the filling material 22 is polymerized to form the polymer 24. This takes place automatically because of the temperature prevailing in the construction space. At this temperature, the monomer 23 as an established processing time, after which the polymerization begins.

In an alternative configuration, the filling material 22 may also be introduced alternately by two printing heads 32, 32′, which contain two components 22a, 22b of the filling material 22. For example, the printing head 32 may contain a mixture 22a of monomer 23, catalyst and reinforcing fibers 25, and the printing head 32′ may contain a mixture 22b of Moderator and monomer 23, activator and reinforcing fibers 25. By the alternate application, thorough mixing then takes place inside the internal space 12. In the mixture activated in this way, the polymerization may be initiated by temporary eating to about 130° C. and subsequently continued at a construction space temperature of between 40° C. and 70° C.

Furthermore, the filling material 22 may also be present in a wax-like consistency such that it can itself function as a support structure for the cover 11e.

In order to keep the result of the polymerization isotropic and homogeneous, polymerization may also be carried out in a high vacuum. In this way, various structural configurations are possible, which may be used deliberately in order to modify the component properties.

FIG. 2e shows the finished object 10 obtain in a perspective representation. After the polymerization, the cavity (internal space part) 12e has been closed with a cover 11g using printing material 21 from the first printing head 31. Subsequently, the object 10, including the carrier structure 14, has been removed from the 3D printer 30 and the carrier structure 14 has been dissolved.

FIG. 2f shows the finished object can in a sectional drawing. Wherever there was filling material 11 during construction, there is now polymer 24, which is reinforced with fibers 25. This fiber-reinforced polymer 24 forms an object structure 28, which represents an isotropic core of the object.

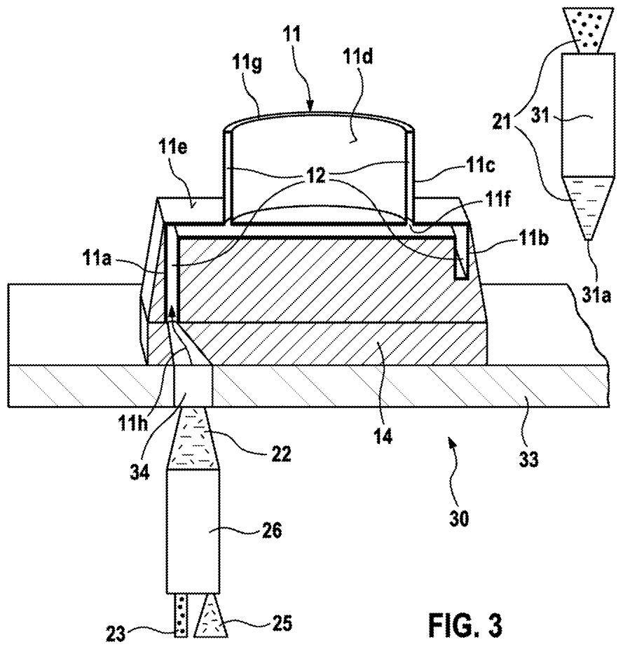

FIG. 3 shows a snapshot of a variant of the process in FIG. 2, in which a different 3D printer 30 specially designed for carrying the method to the invention is used, in partially cutaway section. This 3D printer 30 has, in its base plate 33, a feed-through 34 which can be connected, on a side facing away from the printed structure 11 and the poor as we from the object and as a whole, to a pressurized source 26 of the filling material 22. In the carrier structure 14, as well as in the left-hand limb 11a of the printed structure 11, a passage 11h has been left, through which the filling material 22 can flow into the internal space 12. This partially cutaway view illustrates that ultimately a common internal space 12 extends through the entire printed structure 11, from the limbs 11a and 11b as far as the concentric cylindrical walls 11c and 11d. In contrast to FIG. 2, the printed structure 11 is in this case been manufactured not in stages, which have been interrupted by the application of filling material 22, but in one working step, including the final cover layer 11g. The overhangs may, for example, be produced by corresponding adaptation of the carrier structure 14 which is no longer visible in the state shown in FIG. 3.

It is possible to incorporate mixed structures made of the material 27 of the carrier structure 14 for producing the mixture 22. These may then be jointly removed when removing the carrier structure 14. This allows simpler handling during the polymerization.

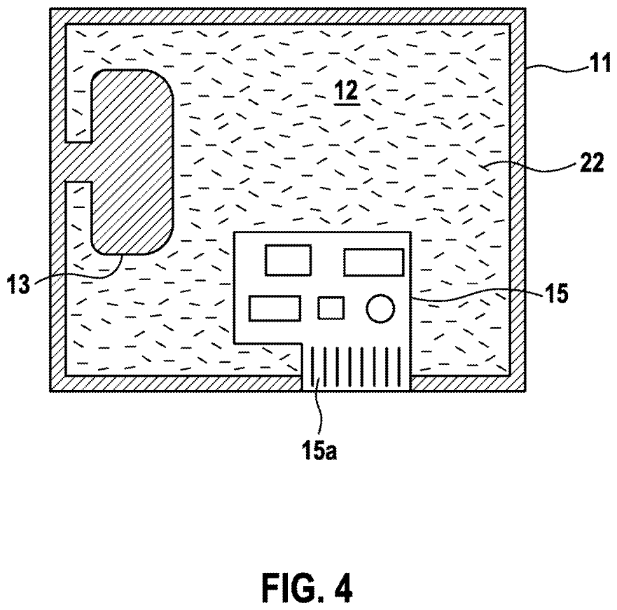

FIG. 4 shows, by way of example, the way in which the connection between the printed structure 11 and an object structure 28, resulting from the filling material 22 after the polymerization, may be reinforced by an indentation 13 of the printed structure 11 in the internal space 12. When the monomer 23 contained in the filling material 22 is polymerized to form the polymer 24, the polymer 24 which is in engagement with the indentation 13 is connected there with a form-fit to the printed structure 11.

Furthermore, FIG. 4 shows the way in which an insert 15 may be cast in the internal space 12 with the filling material 22. In this example, the insert 15 is an electronic printed circuit board having plug-in contacts 15a, to which the printed structure 11 leaves an access open. The printed circuit board 15 is heat-sensitive, and the printing material 21 of which the printed structure 11 consists therefore cannot be cast directly around it, since this printing material 21 does not become liquid until temperatures of 160° C. By casting the filling material 22 and the subsequent polymerization the electronic printed circuit board 15 is not excessively exposed to heat.

1. A method (100) for producing a three-dimensional object (10), the method comprising the following steps:
manufacturing (110) the printed structure (11), which defines an internal space (12), by 3D printing from a printing material (21);
introducing (120) a filling material (22), which comprises at least one liquid or paste-like monomer (23), into the internal space (12); and
polymerizing (130) the monomer (23) to form a polymer (24).

2. The method (100) as claimed in claim 1, characterized in that the internal space (12) defines a negatives shape of an object structure (28) to be produced from the polymer (24), or a part of the object structure (28).

3. The method (100) as claimed in claim 1, characterized in that the filling material contains at least one solid filler (25).

4. The method (100) as claimed in claim 3, characterized in that the solid filler is a reinforcing substance.

5. The method (100) as claimed in claim 1, characterized in that the printing material (21) is composed (110) with a first 3D printing head (31) to form the printed structure (11), and in that the filling material (22) is introduced (120) into the internal space (12) with a second 3D printing head (32).

6. The method (100) as claimed in claim 5, characterized in that an outlet opening (32a) of the second printing head (32) for the filling material (22) has a cross-sectional area which is greater by a factor of at least 2 than an outlet opening (31a) of the first printing head (31) for the printing material (21).

7. The method (100) as claimed in claim 1, characterized in that the printing material is a water-soluble material (21).

8. The method (100) as claimed in claim 1, characterized in that the printed structure (11) is removed (140) from the object (10) after the polymerization (130) of the monomer (23).

9. The method (100) as claimed in claim 1, characterized in that the filling material (22) is brought (125) into engagement with indentations (13) of the printed structure (11), so that a form-fit connection with the indentations (13) is formed after the polymerization (130) of the monomer (23).

10. The method (100) as claimed in claim 1, characterized in that the monomer (23) polymerizes to form a polymer (24) that is materially the same as the printing material (21).

11. The method (100) as claimed in claim 1, characterized in that further printing material (21) is applied (110) by 3D printing after the introduction (120) of the filling material (22).

12. The method (100) as claimed in claim 1, characterized in that the internal space (12) is connected (135) during the polymerization (130) of the monomer (23) to a pressurized source (26) of the filling material (22).

13. The method (100) as claimed in claim 1, characterized in that the printed structure (11) is constructed (110) with the aid of a carrier structure (14) which does not belong to the object (10) and can be separated from the object (10).

14. The method (100) as claimed in claim 1, characterized in that the internal space (12) encloses an insert (15) to be embedded in the object (10).

15. The method (100) as claimed in claim 1, characterized in that caprolactam is selected as the monomer (23) and is polymerized (130) to form the polyamide PA6 as a polymer (24), and/or
propene is selected as the monomer (23) and is polymerized to form PBT as a polymer, and/or
cyclic PBT or CBT is selected as the monomer (23) and is polymerized to form PBT as a polymer, and/or
laurolactam is selected as the monomer (23) and is polymerized (130) to form the polyamide PA12 as a polymer (24).

16. A 3D printer (30) for carrying out a method (100) according to claim 1, characterized in that
a first printing head (31) for the printing material (11) and a second printing head (32) for the filling material (22) are provided, the outlet opening (32a) of the second printing head (32) for the filling material (22) having a cross-sectional area which is greater by a factor of at least 2, preferably by a factor of at least 5, than the outlet opening (31a) of the first printing head (31) for the printing material (21),
and/or
a base plate (33) is provided, on which the printed structure (11) is to be constructed, the base plate (33) having a feed-through (34) for the filling material (22), which feed-through can be connected on the side facing away from the printed structure (11) to a pressurized source (26) of the filling material (22).

17. The method (100) as claimed in claim 3, characterized in that the solid filler is a reinforcing substance in the form of fibers.

18. The method (100) as claimed in claim 5, characterized in that an outlet opening (32a) of the second printing head (32) for the filling material (22) has a cross-sectional area which is greater by a factor of at least 5 than an outlet opening (31a) of the first printing head (31) for the printing material (21).

19. The method (100) as claimed in claim 1, characterized in that the printing material is a water-soluble gelatin.
